(19) United States
(12) Patent Application Publication
(10) Pub. No.: US 2009/0226144 A1
(43) Pub. Date: Sep. 10, 2009

(54) DIGEST GENERATION DEVICE, DIGEST GENERATION METHOD, RECORDING MEDIUM STORING DIGEST GENERATION PROGRAM THEREON AND INTEGRATED CIRCUIT USED FOR DIGEST GENERATION DEVICE

(76) Inventors: Takashi Kawamura, Kyoto (JP); Meiko Maeda, Kanagawa (JP); Kazuhiro Kuroyama, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/994,827

(22) PCT Filed: Jul. 24, 2006
(86) PCT No.: PCT/JP2006/314589

§ 371 Date: Jan. 4, 2008

(30) Foreign Application Priority Data
Jul. 27, 2005 (JP) 2005-217724

(51) Int. Cl. H04N 5/93; H04N 5/91; G11B 27/00

(52) U.S. Cl. 386/52; 386/96; 386/E05.052; 386/46

(57) ABSTRACT

A feature amount calculating section (12) calculates a feature amount based on received AV signals. A silent segment detecting section (13) detects a segment having an audio power level smaller than or equal to a predetermined value as a silent segment. A candidate segment detecting section (14) detects a segment having the audio power level greater than or equal to the predetermined value as a digest scene candidate segment. A CM segment determining section (15) determines a CM segment based on a time difference between the silent segment and another silent segment. A digest list creating section (16) deletes a determined segment corresponding to the CM segment from digest candidate segments, thereby generating digest scene information based on a program segment excluding the CM segment.

### TECHNICAL FIELD

The present invention relates to generation of a digest scene, and more particularly to generation of a digest scene by calculating a feature amount of a video or audio transmitted through a television broadcast and determining a specific important scene based on the calculated feature amount.

### BACKGROUND ART

Conventionally, there is a digest (summary) generation device for calculating a feature amount of a video and audio transmitted through a television broadcast so as to determine an important scene by means of the calculated feature amount. In such a digest generation device, the following scheme is generally used for generating a digest. Firstly, a feature amount of the video and audio is calculated for one program based on an AV signal which has been recorded on a recording medium, and a Commercial Messages (CM) segment is detected based on the calculated feature amount, thereby calculating time information, for example, on a playlist for reproducing the digest based on segments excluding the CM segment.

A configuration of a digest generation device adopting the above-mentioned scheme will be described with reference to FIG. 14. FIG. 14 is a diagram illustrating an exemplary configuration of a digest generation device for generating a digest in which the CM segment is removed. In FIG. 14, a receiving section 101 receives a broadcast wave and demodulates the broadcast wave into an audio/video signal (hereinafter, referred to as an AV signal). A mass storage medium 102 is a device for recording the received AV signal. The mass storage medium 102 is an HDD, for example. The feature amount extracting section 103 calculates a feature amount required for generating the digest (hereinafter, referred to as a digest feature amount) and a feature amount required for detecting a CM (hereinafter, referred to as a CM feature amount) based on the AV signal stored on the mass storage medium 102. Note that the digest feature amount may be a detection result of scene changes generated based on a motion vector and brightness level information, an audio power, text information assigned to a program or the like. Also, the CM feature amount may be a detection result of scene changes generated based on the brightness level information, information on an audio silent portion or the like. A CM detecting section 104 detects (time information on beginning and terminating ends of) a CM segment based on the calculated CM feature amount, and outputs the detected CM segment to a digest detecting section 105. As a method of detecting the CM segment, there is a method in which scene changes of an image are detected based on brightness level information of the image, thereby determining, if a time interval between time points at which the scene changes appear is a constant time period (15 seconds or 30 seconds), that a portion between the scene changes is the CM segment, or there is a method in which the audio silent portions are detected, thereby checking a time interval between time points at which the audio silent portions appear in a similar manner as mentioned above, so as to determine that a portion between the audio silent portions is the CM segment. A digest detecting section 105 detects a digest scene from segments other than the CM segment, based on the digest feature amount and CM segment information outputted from the CM detecting section 104. Furthermore, the digest detecting section 105 also outputs (the time information on the beginning and terminating ends of) the detected digest scene to a reproduction controlling section 106 as digest information. As a method of detecting the digest scene, in the case of sports broadcast or the like, there is a method of specifying a scene showing a slow motion (a repeated slow motion scene) based on the motion vector of an image and detecting several scenes immediately preceding the scene showing the slow motion as scenes of excitement (patent document 1, for example), or a method of detecting a scene having a large value of local audio power information as a scene of excitement (patent document 2, for example), or a method of detecting an important scene by combining the text information assigned to the program and the feature amount of the audio/video signal (patent document 3, for example). The reproduction controlling section 106 reads the AV signal from the mass storage medium 102 and reproduces the digest based on the digest information. With such a configuration, when a user views a recorded program, that is, when the AV signal stored on the mass storage medium 102 is reproduced, it is possible to generate the digest scene information based on a program segment excluding the CM segment so as to reproduce the digest.

Furthermore, there is another scheme in which a feature amount is calculated simultaneously when recording a program so as to be previously stored on a recording medium. FIG. 19 is a diagram illustrating an exemplary configuration of a digest generation device. In the digest generation device, while calculating the feature amount simultaneously when performing a recording process, a digest scene candidate is detected in real time so as to be previously stored in mass storage means together with the CM feature amount, and then a CM segment is detected when reproducing a program and the CM segment is excluded from the detected digest scene candidate, thereby generating correct digest information. In FIG. 19, when recording a received AV signal on the mass storage medium 102, the receiving section 101 simultaneously outputs the AV signal to the feature amount extracting section 103. The feature amount extracting section 103 calculates the CM feature amount so as to be stored on the mass storage medium 102. In accordance with this, the feature amount extracting section 103 outputs a digest feature amount such as an audio power level to the digest detecting section 105. The digest detecting section 105 analyzes the digest feature amount, thereby detecting a scene having, for example, the audio power level greater than or equal to a predetermined threshold value as a digest scene candidate. Thereafter, the digest detecting section 105 stores the detected scene on the mass storage medium 102 as digest candidate information. That is, a scene which is to be determined as a digest candidate is detected simultaneously when recording the program. Then, the digest candidate information (time information) and the CM feature amount are recorded on the mass storage medium 102. Note that for detecting a CM, beginning and terminating ends of a CM segment cannot be specified in real time, and thus only a CM feature amount which is required for a subsequent detection process is recorded. Then, when the recorded program is reproduced in accordance with an instruction from the user, the CM detecting section 104 reads the CM feature amount from the mass storage medium 102, thereby detecting the CM segment. Thereafter, the CM detecting section 104 outputs a detection result to the CM segment removing section 107 as the CM segment information. The CM segment removing section 107 removes a portion corresponding to the CM segment from the digest candidate information read from the mass storage medium 102, thereby generating the digest information. In other words, while recording the program, a scene, including the CM segment, having the audio power level greater than or equal to the predetermined value, for example, is temporarily detected, and the scene is recorded as the digest candidate information. Thereafter, when a reproduction start instruction is received, for example, after finishing recording the program, an entirety of (the feature amount of) the recorded program is analyzed so as to detect the CM segment, and the CM segment is removed from a digest candidate, thereby extracting a digest segment included in the program segment.

[patent document 1] Japanese Laid-Open Patent Publication No. 2004-128550

[patent document 2] Japanese Laid-Open Patent Publication No. 10-039890

[patent document 3] Japanese Laid-Open Patent Publication No. 2001-119649

### DISCLOSURE OF THE INVENTION

### Problems to be Solved by the Invention

The aforementioned digest generation devices have the following problems. Firstly, in a first scheme, when a digest reproduction start instruction is received from the user, for example, after finishing recoding the program, processes such as a feature amount calculation, CM segment detection, digest scene detection and digest information creation are executed. Therefore, there is a problem in that after receiving the digest reproduction start instruction, awaiting time period is generated until the program actually starts to be reproduced. Also, in a second scheme, while recording the program, the feature amount is calculated and the information on the scene which is to be determined as the digest candidate is detected. Thus, a time period required for a process of calculating the feature amount can be reduced as compared to the first scheme in which the process of calculating the feature amount is executed at the time of the reproduction start instruction. However, for detecting the CM segment, the beginning and terminating ends of the CM segment cannot be determined in real time. Thus, the CM segment has to be detected after finishing recording the program (at the time of the reproduction start instruction, for example). Therefore, even in this scheme, the waiting time period required for a process of creating the digest information is generated. In general, a general consumer product such as a DVD recorder, in particular, typically stores a CPU having approximately one-tenth of performance of that stored in a personal computer. Therefore, the aforementioned waiting time period is prolonged, thereby providing the user with unfavorable impressions such as uncomfortable feelings and poor usability due to the aforementioned waiting time period.

Therefore, an object of the present invention is to provide a digest generation device for creating no waiting time required for the process of generating, after finishing recording a program, the digest information of the program.

### Solution to the Problems

To achieve the above object, the present invention has the following aspects.

A first aspect is a digest generation device for generating, when receiving broadcast signals of a program to be broadcast and recording the broadcast signals on a recording medium, digest scene information concerning the program, comprising a feature amount calculating section, a specific segment end detecting section, and a digest scene information creating section. The feature amount calculating section calculates, each time the broadcast signals corresponding to a unit time period are received, at least one type of a feature amount indicating a characteristic of at least one of video and audio included in the broadcast signals based on the received broadcast signals corresponding to the unit time period. The specific segment end detecting section detects time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end. The digest scene information creating section determines, each time the feature amount is calculated, whether or not the broadcast signals included in segments, other than the specific segment, of an entire segment of the program are included in a digest scene based on the feature amount so as to generate digest scene information.

In a second aspect based on the first aspect, the digest scene information creating section includes a digest segment detecting section for detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount. Furthermore, the digest scene information creating section determines, each time the specific segment end detecting section detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting section as the digest scene information.

In a third aspect based on the first aspect, the digest scene information creating section includes a temporary storage section for storing the calculated feature amount for a predetermined time period from a most recent calculation time point. Furthermore, the digest scene information creating section determines, each time the feature amount is calculated, whether or not the most recent calculation time point of the feature amount stored in the temporary storage section is included in the specific segment from the beginning end to the terminating end which are detected by the specific segment end detecting section, and detects, when it is determined that the most recent calculation time point is not included in the specific segment, at least one content of the digest scene from contents included in the broadcast signals corresponding to the unit time period so as to generate the digest scene information.

In a fourth aspect based on the second aspect, the feature amount calculating section calculates a first feature amount and a second feature amount, the specific segment end detecting section determines the beginning end or the terminating end of the specific segment based on the first feature amount, and the digest segment detecting section detects any of the digest candidate segments based on the second feature amount.

In a fifth aspect based on the first aspect, the specific segment end detecting section includes: a specific segment candidate detecting section for detecting, when the feature amount satisfies a predetermined condition, a segment including only the feature amount satisfying the condition as a specific segment candidate; and a specific segment determining section for detecting a candidate of the beginning end or the terminating end of the specific segment based on a time difference between the specific segment candidate and another specific segment candidate, both of which are included in the program.

In a sixth aspect based on the fifth aspect, each time the specific segment candidate is detected, the specific segment determining section determines, if a time point which is a predetermined time period prior to the detected specific segment candidate is included in an already-detected specific segment candidate, the time point which is the predetermined time period prior to the detected specific segment candidate as the beginning end of the specific segment and the detected specific segment candidate as the terminating end of the specific segment.

In a seventh aspect based on the fifth aspect, the specific segment detecting section includes: a determination section for determining, each time the specific segment candidate is detected, whether or not an already-detected specific segment candidate exists at a time point which is a predetermined first time period prior to a most recently detected specific segment candidate or at a time point which is a predetermined second time period prior to the most recently detected specific segment candidate; an addition section for adding, when the determination section determines that the already-detected specific segment candidate exists at either of the time points, a point to each of the already-detected specific segment candidate and the most recently detected specific segment candidate; a beginning end determining section for determining, each time a predetermined third time period is elapsed since a target candidate having the point greater than or equal to a predetermined value is detected, whether or not the specific segment candidate having the point greater than or equal to the predetermined value exists at a time point which is the predetermined third time period prior to the target candidate, and determining, if the specific segment candidate having the point greater than or equal to the predetermined value does not exist at the time point which is the predetermined third time period prior to the target candidate, the target candidate as the beginning end of the specific segment; and a terminating end determining section for determining, each time the predetermined third time period is elapsed since the target candidate having the point greater than or equal to the predetermined value is detected, whether or not the specific segment candidate having the point greater than or equal to the predetermined value exists at a time point at which the predetermined third time period is elapsed, and determining, if the specific segment candidate having the point greater than or equal to the predetermined value does not exist at the time point at which the predetermined third time period is elapsed, the target candidate as the terminating end of the specific segment.

In an eighth aspect based on the fifth aspect, the feature amount calculating section calculates an audio power level of an audio signal as the feature amount, and the specific segment candidate detecting section detects a silent segment having a power level smaller than or equal to a predetermined value as the specific segment candidate.

In a ninth aspect based on the fifth aspect, the feature amount calculating section calculates brightness level information obtained based on a video signal as the feature amount, and the specific segment candidate detecting section detects a scene change point having a change amount, of the brightness level information, greater than or equal to a predetermined value as the specific segment candidate.

A tenth aspect is a digest generation method of generating, when receiving broadcast signals of a program to be broadcast and recording the broadcast signals on a recording medium, digest scene information concerning the program, comprising a feature amount calculation step, a specific segment end detecting step, and a digest scene information creating step. The feature amount calculating step calculates, each time the broadcast signals corresponding to a unit time period are received, at least one type of a feature amount indicating a characteristic of at least one of video and audio included in the broadcast signals based on the received broadcast signals corresponding to the unit time period. The specific segment end detecting step detects time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end. The digest scene information creating step determines, each time the feature amount is calculated, whether or not the broadcast signals included in segments, other than the specific segment, of an entire segment of the program are included in a digest scene based on the feature amount so as to generate digest scene information.

In an eleventh aspect based on the tenth aspect, the digest scene information creating step includes a digest segment detecting step of detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount. Furthermore, the digest scene information creating step determines, each time the specific segment end detecting step detects a pair of the beginning end and the terminating end of the specific segment, whether or not the specific segment from the beginning end to the terminating end overlaps one of the digest candidate segments so as to generate information indicating at least one segment, other than the one of the digest candidate segments which overlaps the specific segment, included in the digest candidate segments detected by the digest segment detecting step as the digest scene information.

In a twelfth aspect based on the tenth aspect, the digest scene information creating step includes a temporary storage step of storing the calculated feature amount for a predetermined time period from a most recent calculation time point. Furthermore, the digest scene information creating step determines, each time the feature amount is calculated, whether or not the most recent calculation time point of the feature amount stored in the temporary storage step is included in the specific segment from the beginning end to the terminating end which are detected by the specific segment end detecting step, and detects, when it is determined that the most recent calculation time point is not included in the specific segment, at least one content of the digest scene from contents included in the broadcast signals corresponding to the unit time period so as to generate the digest scene information.

A thirteenth aspect is a recoding medium storing a digest generation program executed by a computer of a digest generation device for generating, when receiving broadcast signals of a program to be broadcast and recording the broadcast signals on a recording medium, digest scene information concerning the program, the digest generation program storing a feature amount calculation step, a specific segment end detecting step, and a digest scene information creating step. The feature amount calculating step calculates, each time the broadcast signals corresponding to a unit time period are received, at least one type of a feature amount indicating a characteristic of at least one of video and audio included in the broadcast signals based on the received broadcast signals corresponding to the unit time period. The specific segment end detecting step detects time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end. The digest scene information creating step determines, each time the feature amount is calculated, whether or not the broadcast signals included in segments, other than the specific segment, of an entire segment of the program are included in a digest scene based on the feature amount so as to generate digest scene information.

In a fourteenth aspect based on the thirteenth aspect, the digest scene information creating step includes a digest segment detecting step of detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount. Furthermore, the digest scene information creating step determines, each time the specific segment end detecting step detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting step as the digest scene information.

In a fifteenth aspect based on the thirteenth aspect, the digest scene information creating step includes a temporary storage step of storing the calculated feature amount for a predetermined time period from a most recent calculation time point. Furthermore, the digest scene information creating step determines, each time the feature amount is calculated, whether or not the most recent calculation time point of the feature amount stored in the temporary storage step is included in the specific segment from the beginning end to the terminating end which are detected by the specific segment end detecting step, and detects, when it is determined that the most recent calculation time point is not included in the specific segment, at least one content of the digest scene from contents included in the broadcast signals corresponding to the unit time period so as to generate the digest scene information.

A sixteenth aspect is an integrated circuit used for a digest generation device for generating, when receiving broadcast signals of a program to be broadcast and recording the broadcast signals on a recording medium, digest scene information concerning the program, comprising a feature amount calculating section, a specific segment end detecting section, and a digest scene information creating section. The feature amount calculating section calculates, each time the broadcast signals corresponding to a unit time period are received, at least one type of a feature amount indicating a characteristic of at least one of video and audio included in the broadcast signals based on the received broadcast signals corresponding to the unit time period. The specific segment end detecting section detects time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end. The digest scene information creating section determines, each time the feature amount is calculated, whether or not the broadcast signals included in segments, other than the specific segment, of an entire segment of the program are included in a digest scene based on the feature amount so as to generate digest scene information.

In a seventeenth aspect based on the sixteenth aspect, the digest scene information creating section includes a digest segment detecting section for detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount. Furthermore, the digest scene information creating section determines, each time the specific segment end detecting section detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting section as the digest scene information.

In an eighteenth aspect based on the sixteenth aspect, the digest scene information creating section includes a temporary storage section for storing the calculated feature amount for a predetermined time period from a most recent calculation time point. Furthermore, the digest scene information creating section determines, each time the feature amount is calculated, whether or not the most recent calculation time point of the feature amount stored in the temporary storage section is included in the specific segment from the beginning end to the terminating end which are detected by the specific segment end detecting section, and detects, when it is determined that the most recent calculation time point is not included in the specific segment, at least one content of the digest scene from contents included in the broadcast signals corresponding to the unit time period so as to generate the digest scene information.

### EFFECT OF THE INVENTION

According to the first invention, the specific segment (a CM segment, for example) can be detected while recording a program. Therefore, the digest scene information in which the specific segment is removed can be simultaneously generated while recording the program. Thus, a waiting time period required for executing, after finishing recording the program, a process of generating the digest scene information can be eliminated, thereby making it possible to provide the user with a conformable digest reproduction operation. Furthermore, in the case where a follow-up reproduction is performed while recording the program, a digest reproduction also can be reproduced up to a time period close to that at which the program is currently being recorded thereby making it possible to provide the user with a reproduction environment with better usability.

According to the second and third inventions, an effect similar to that of the first invention can be obtained.

According to the fourth invention, the two types of feature amounts are used. Therefore, either of the feature amounts which is appropriate for detecting each of the specific segment and the digest segment is used, thereby making it possible to more accurately detect each of the specific segment and the digest segment.

According to the fifth and sixth inventions, the specific segment is determined based on the time interval between time points of the specific segment candidate and the said another specific segment candidate. Thus, it becomes possible to more accurately determine the specific segment.

According to the seventh invention, the point is added to each of the specific segment candidates based on the predetermined time intervals. Therefore, it becomes possible to assess how likely each of the specific segment candidates is to be located at the beginning end or the terminating end of the specific segment. Furthermore, the specific segment candidate having a higher point is determined as the beginning end or the terminating end of the specific segment, thereby making it possible to prevent a specific segment candidate accidentally existing in a program from being mistakenly determined as the beginning end or the terminating end of the specific segment. As a result, it becomes possible to create the digest scene information in which the specific segment is more accurately removed.

According to the eighth invention, the silent segment is the specific segment candidate. Therefore, the specific segment such as the CM segment can be more accurately detected, utilizing properties that the silent segments are located at the both beginning and end of the CM segment.

According to the ninth invention, the scene change point at which the brightness level information is substantially changed is the specific segment candidate. Therefore, a scene change portion, from a program to the specific segment, in which the brightness level information is substantially changed can be determined as the specific segment candidate. As a result, it becomes possible to more accurately determine the specific segment.

According to the tenth to eighteenth inventions, an effect similar to that of the first embodiment can be obtained.

### BRIEF DESCRIPTION OF THE DRAWINGS

FIG. 1 is a block diagram illustrating a configuration of a digest generation device 10 according to a first embodiment of the present invention.

FIG. 2 is a diagram illustrating an example of data used in the present invention.

FIG. 3 is a flowchart illustrating a digest scene list generating process.

FIG. 4 is a flowchart illustrating details of a silent segment detecting process shown in step S4 of FIG. 3.

FIG. 5 is a flowchart illustrating details of a point assessment process shown in step S16 of FIG. 4.

FIG. 6 is a flowchart illustrating details of a candidate segment detecting process shown in step S5 of FIG. 3.

FIG. 7 is a flowchart illustrating details of a CM segment determining process shown in step S6 of FIG. 3.

FIG. 8 is a diagram illustrating an example of a CM segment determined by the CM segment determining process.

FIG. 9 is a flowchart illustrating details of a digest scene list outputting process shown in step S7 of FIG. 3.

FIG. 10 is a block diagram illustrating a configuration of the digest generation device 10 according to a second embodiment.

FIG. 11 is a diagram illustrating an example of data used in the present invention.

FIG. 12 is a diagram illustrating the digest scene list according to the second embodiment.

FIG. 13 is a flowchart illustrating details of the silent segment detecting process shown in step S66 of FIG. 12.

FIG. 14 is a block diagram illustrating a configuration of a conventional recording/reproducing device.

FIG. 15 is a block diagram illustrating another configuration of the conventional recording/reproducing device.

### DESCRIPTION OF THE REFERENCE CHARACTERS

10, 30 digest generation device
11 receiving section
12 feature amount calculating section
13 silent segment detecting section
14 candidate segment detecting section
15 CM segment determining section
16, 32 digest list creating section
17 mass recording medium
18 reproduction controlling section
21 compared feature amount information
22 silent beginning end information
23 candidate beginning end information
24 silent segment information
25 candidate segment information
26 temporary CM beginning end information
27 CM segment information
28 digest scene list
31 temporary storage section
36 temporary accumulated feature amount
37 immediately preceding digest information
38 digest beginning end information

### BEST MODE FOR CARRYING OUT THE INVENTION

According to the present invention, a digest scene list indicating positions of digest scenes is simultaneously created while recording a program. In embodiments of the present invention to be described below, a scene locally having a large value of an audio power level, i.e., a scene of excitement, is adopted as a digest scene. Therefore, a scene having an audio power level greater than or equal to a predetermined value is extracted as a digest candidate segment. In accordance with this, a segment having the audio power level smaller than or equal to the predetermined value is also extracted as a silent segment, and a segment between the silent segments appearing at times having a predetermined interval (15 seconds, for example) therebetween is extracted as a Commercial Messages (CM) segment. This is because, since the CM segment has properties that the silent segments exit at the beginning and end of the CM segment and the CM segment has a constant length, a portion between the silent segments appearing at times having a constant time interval therebetween may be considered as the CM segment. Each time the CM segment is extracted, information corresponding to the CM segment is removed from information on the digest candidate segment, thereby creating the digest scene list indicating the digest scenes included in a program segment. Note that in the present embodiments, a maximum length of one CM segment is 60 seconds.

### First Embodiment

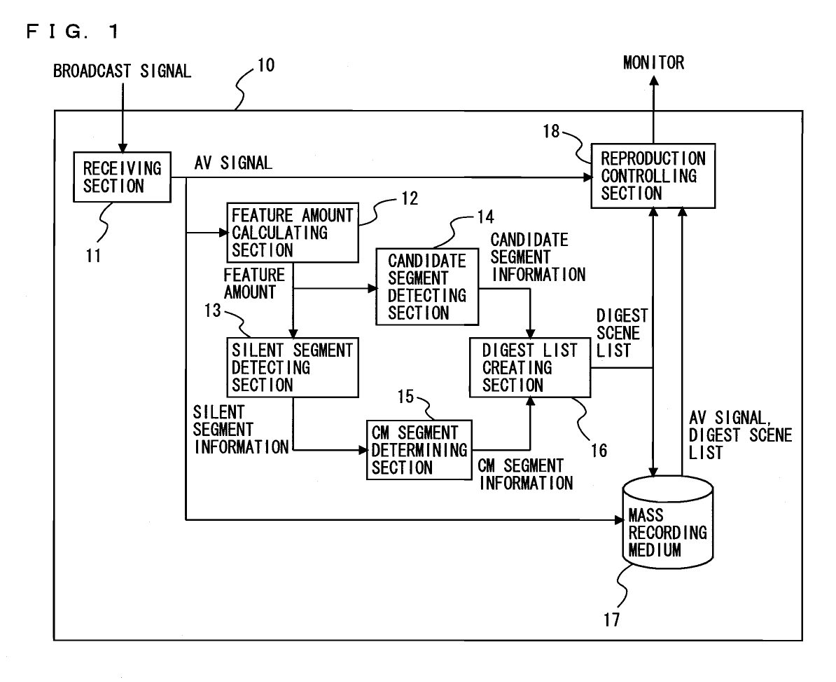

FIG. 1 is a block diagram illustrating a configuration of a digest generation device according to a first embodiment of the present invention. In FIG. 1, the digest generation device 10 comprises a receiving section 11, a feature amount calculating section 12, a silent segment detecting section 13, a candidate segment detecting section 14, a CM segment determining section 15, a digest list creating section 16, a mass recording medium 17, and a reproduction controlling section 18.

The receiving section 11 receives a broadcast signal and demodulates the signal into a video and audio signal (hereinafter an AV signal). Also, the receiving section 11 outputs the demodulated AV signal to the feature amount calculating section 12, the mass recording medium 17, and the reproduction controlling section 18.

The feature amount calculating section 12 analyzes the AV signal so as to calculate a feature amount, and outputs the feature amount to the silent segment detecting section 13 and the candidate segment detecting section 14. Note that the feature amount is used for determining the CM segment or digest scene included in the program. As the feature amount used for determining the CM segment, an audio feature amount such as a power level or power spectrum of an audio signal may be used, for example, since the CM segment is determined based on a time interval between time points at which the silent segments appear as described above. On the other hand, as the feature amount used for determining the digest scene, a video feature amount such as brightness level information and a motion vector of the video signal, or the audio feature amount such as the power level or power spectrum of the audio signal may be used, for example. In the present embodiment, the power level of the audio signal is used, as the feature amount, for determining both the CM segment and the digest scene.

The silent segment detecting section 13 detects the silent segment included in the program based on the aforementioned feature amount, and generates silent segment information 24. Also, the silent segment detecting section 13 outputs the silent segment information 24 to the CM segment determining section 15. The candidate segment detecting section 14 detects a segment which is to be determined as a digest scene candidate (hereinafter a candidate segment) included in the program based on the aforementioned feature amount, and generates candidate segment information 25. Also, the candidate segment detecting section 14 outputs the candidate segment information 25 to the digest list creating section 16.

Based on the silent segment information 24, the CM segment determining section 15 determines the CM segment by checking the time interval between the time points at which the silent segments appear. Then, the CM segment determining section 15 outputs the determined CM segment to the digest list creating section 16 as the CM segment information 27.

Based on the candidate segment information 25 and the CM segment information 27, the digest list creating section 16 creates a digest scene list 28 which is information indicating the positions of the digest scenes. Then, the digest list creating section 16 outputs the digest scene list 28 to the mass recording medium 17 and the reproduction controlling section 18.

The mass recording medium 17 is a medium for recording the AV signal or the digest scene list 28 thereon, and is a DVD, an HDD or the like.

The reproduction controlling section 18 performs a reproduction control such as reproducing the received AV signal or the AV signal recorded on the mass recording medium and outputting the aforementioned signals to a monitor.

Note that the feature amount calculating section 12, the silent segment detecting section 13, the candidate segment detecting section 14, the CM segment determining section 15 and the digest list creating section 16, all of which are shown in FIG. 1, may be typically a LSI acting as an integrated circuit. The feature amount calculating section 12, the silent segment detecting section 13, the candidate segment detecting section 14, the CM segment determining section 15 and the digest list creating section 16 may be individually made into chips or integrally made into one chip such that one chip includes a portion or all of the above components. Furthermore, as a method of realizing the above components as the integrated circuit, the integrated circuit is not limited to the LSI. Instead of the LSI, a dedicated circuit or a generalized processor may be used.

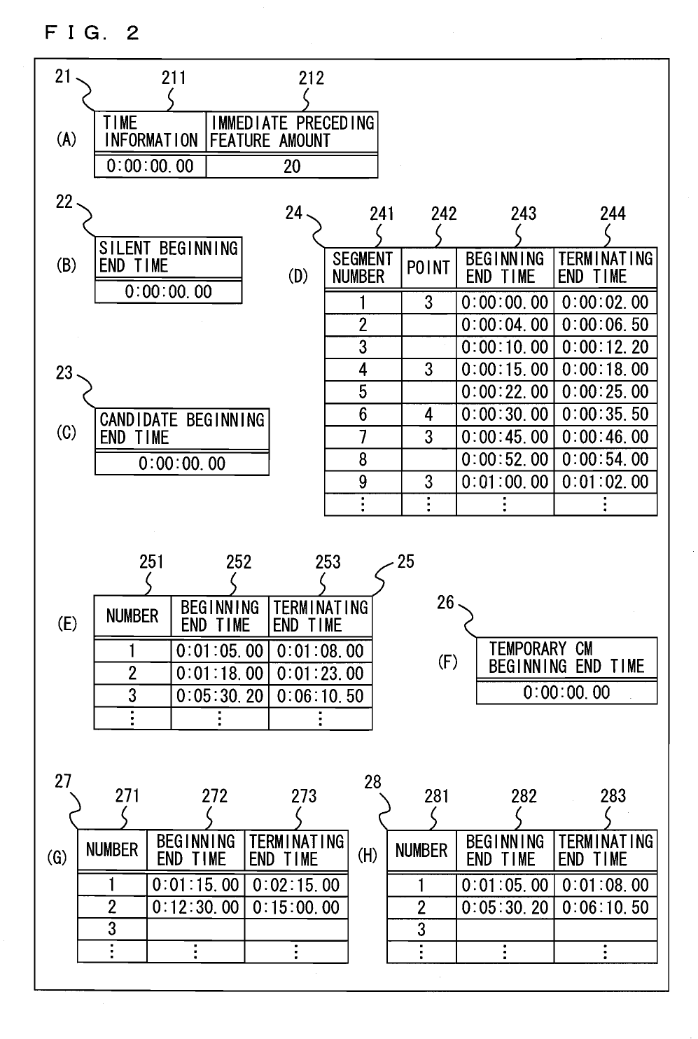

Next, various data used in the present embodiment will be described with reference to FIG. 2. The various data to be described below is stored in a temporary storage section (not shown) which is realized by a semiconductor memory, for example. In FIG. 2, compared feature amount information 21 (FIG. 2(A)) is used for detecting the aforementioned silent segment or the like. The compared feature amount information 21 has time information 211 on an immediately preceding frame and an immediately preceding feature amount 212 storing a value of the audio power level calculated by the feature amount calculating section 12.

Silent beginning end information 22 (FIG. 2(B)) has a silent beginning end time, and is used for detecting the silent segment.

Candidate beginning end information 23 (FIG. 2(C)) has a candidate beginning end time, and is used for detecting the candidate segment.

The silent segment information 24 (FIG. 2(D)) stores a detection result of the silent segments detected by the silent segment detecting section 13. The silent segment information 24 is comprised of a segment number 241, a point 242, a beginning end time 243 and a terminating end time 244. The segment number 241 is a number for identifying the silent segments to each other. The point 242 is a value for assessing how close the silent segment may be located to each end of the CM segment. The higher the point is, the more likely the silent segment is to be located at each end of the CM segment. On the other hand, the lower the point is, the more likely the silent segment is to be accidentally appeared during the program (i.e., the silent segment is not located at each end of the CM segment). The beginning end time 243 and the terminating end time 244 are time information indicating a start time and a finish time of the silent segment, respectively.

The candidate segment information 25 (FIG. 2E)) stores a detection result of the candidate segments detected by the candidate segment detecting section 14. The candidate segment information 25 is comprised of a candidate number 251, a starting end time 252 and a terminating end time 253. The candidate number 251 is a number for identifying the candidate segments to each other. The beginning end time 252 and the terminating end time 253 are time information indicating a start time and a finish time of the candidate segment, respectively.

Temporary CM beginning end information 26 (FIG. 2(F)) has a temporary CM beginning end time used when the CM segment determining section 15 detects the CM segment, and stores a beginning end time of the silent segment which may be located at a beginning end of the CM segment.

CM segment information 27 (FIG. 2(G)) stores information on the CM segments detected by the CM segment determining section 15. The CM segment information 27 is comprised of a CM number 271, a CM beginning end time 272 and a CM terminating end time 273. The CM number 271 is a number for identifying the CM segments to each other. The CM beginning end time 272 and the CM terminating end time 273 are time information indicating a start time and a finish time of the CM segment, respectively.

Digest scene list 28 (FIG. 2(H)) is a file indicating time information on segments which are to be determined as the digest scenes included in the program. The digest scene list 28 is comprised of a digest number 281, a digest beginning end time 282 and a digest terminating end time 283. The digest number 281 is a number for identifying the digest segments to each other. The digest beginning end time 282 and the digest terminating end time 283 are time information indicating a start time and a finish time of the digest segment, respectively.

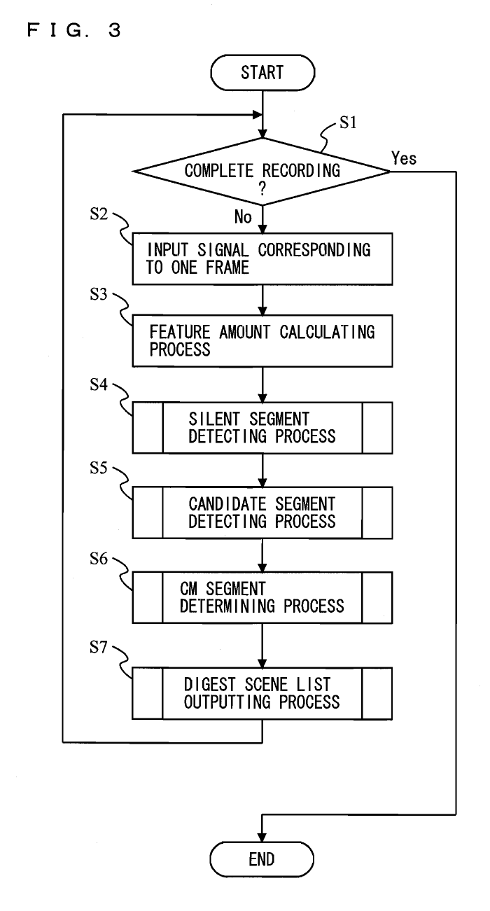

Hereinafter, a detailed operation of a digest scene list creating process executed by the digest generation device 10 will be described with reference to FIGS. 3 to 9. FIG. 3 is a flowchart illustrating the detailed operation of the digest scene list creating process according to the first embodiment. The process shown in FIG. 3 is started by a recording instruction from the user. Further, a scanning time of the process shown in FIG. 3 is one frame.

In FIG. 3, the digest generation device 10 determines whether or not completion of recording is instructed (step S1). As a result, when it is determined that the completion of recording is instructed (YES in step S1), the digest scene list creating process is to be finished. On the other hand, when it is determined that the completion of recording is not instructed (NO in step S1), the feature amount calculating section 12 acquires a signal corresponding to one frame from the receiving section 11 (step S2). Then, the feature amount calculating section 12 analyzes the acquired signal, thereby calculating the audio power level (feature amount) (step S3).

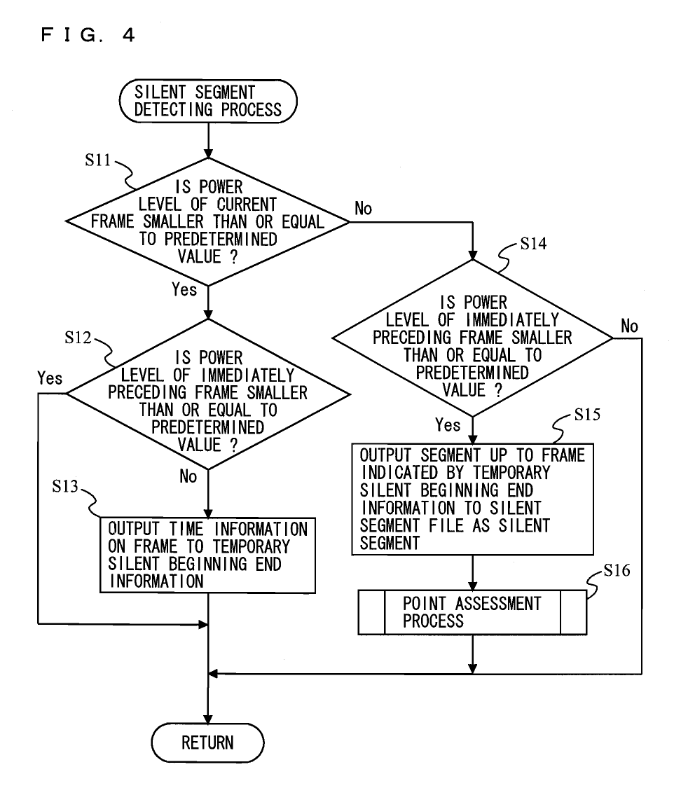

Next, the silent segment detecting section 13 executes a silent segment detecting process, thereby detecting the silent segments (step S4). FIG. 4 is a flowchart illustrating details of the silent segment detection process shown in step S4. In FIG. 4, the silent segment detecting section 13 determines whether or not the power level of the audio signal calculated in step S3 is smaller than or equal to a predetermined threshold value (step S11). As a result, when it is determined that the power level is smaller than or equal to the predetermined threshold value (YES is step S11), the silent segment detecting section 13 reads the immediately preceding feature amount 212 storing a feature amount corresponding to an immediately preceding frame, thereby determining whether or not a value thereof is smaller than or equal to the predetermined threshold value (step S12). That is, a change in the audio power level between a current frame and a frame immediately preceding the current frame is determined. As a result, when it is determined that the value of the immediately preceding feature amount 212 is not smaller than or equal to the predetermined threshold value (NO in step S12), the silent segment detecting section 13 stores the time information on the current frame in the silent beginning end information 22 (step S13). Note that immediately after the process is started, any information is not yet stored in the immediately preceding feature amount 212. Therefore, in this case, the process proceeds assuming that the value is not smaller than or equal to the predetermined threshold value. On the other hand, when it is determined that the value of the immediately preceding feature amount 212 is smaller than or equal to the predetermined threshold value (YES in step S12), the silent segment is continuing, and thus the silent segment detecting process is to be finished.

On the other hand, as a result of step S11, when it is determined that the power level of the audio signal extracted in step S3 is not smaller than or equal to the predetermined threshold value (NO in step S11), the silent segment detecting section 13 reads the immediately preceding feature amount 212, thereby determining whether or not a power level stored therein is smaller than or equal to the predetermined threshold value (step S14). As a result, when it is determined that the power level is smaller than or equal to the predetermined threshold value (YES in step S14), a continued silent segment ends after the frame immediately preceding the current frame. Thus, the silent segment detecting section 13 outputs, to the silent segment information 24, a segment from the silent beginning end time of the silent beginning time information 22 to the time information 211 on the frame immediately preceding the current frame as one silent segment (step S15). Next, the silent segment detecting section 13 executes a point assessment process (step S16) on the silent segment outputted in step S15, as will be described hereinafter.

As a result of step S14, when it is determined that the power level of the immediately preceding feature amount 212 is not smaller than or equal to the predetermined threshold value (NO in step S14), a segment other than the silent segment is continuing, and thus the silent segment detecting section 13 finishes the process. Note that immediately after the process is started, any information is not yet stored in the immediately preceding feature amount 212. Therefore, also in this case, the process proceeds assuming that the power level is not smaller than or equal to the predetermined threshold value. As such, the silent segment detecting process is finished.

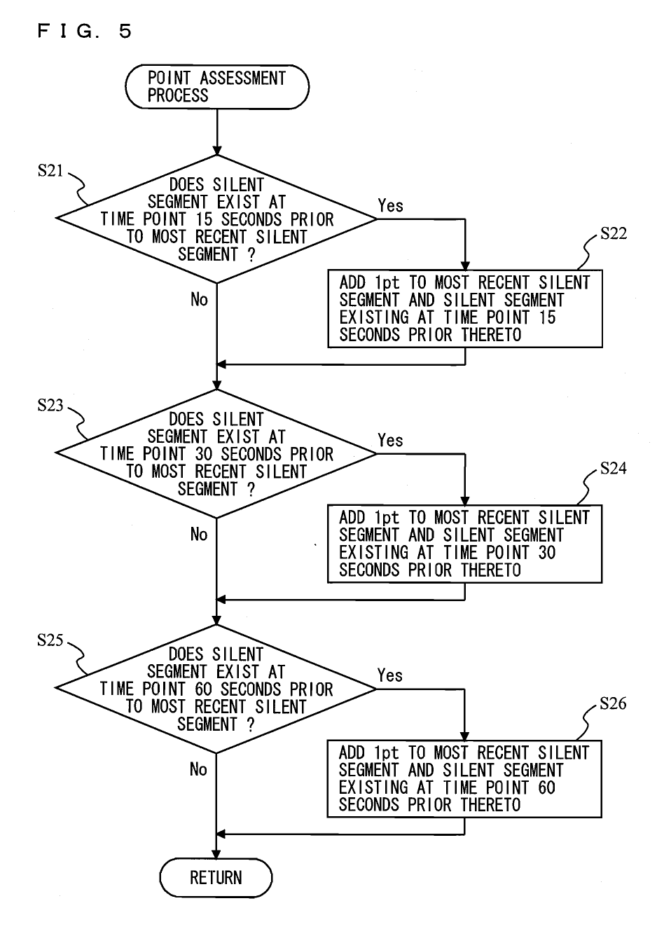

Next, the point assessment process in step S16 will be described in detail with reference to FIG. 5. In the point assessment process, whether or not time points 15 seconds, 30 seconds and 60 seconds prior to a most recently detected silent segment are respectively included in silent segments. When it is determined that each of the time points is included in a silent segment, one point is added to the most recently detected silent segment and the silent segment. Therefore, the more likely a silent segment is to be located at a beginning end or a terminating end of any CM, the higher a point of the silent segment can be. That is, utilizing properties that the silent segments are located at the both ends of the CM segment and a length of one CM segment is 15 seconds, 30 seconds or 60 seconds, the process is executed so as to assess “how likely a silent segment appearing during the program is to be located at each end of a CM segment” by adding a point to the silent segment. As a result, it is possible to distinguish a silent segment accidentally appearing during the program from another silent segment indicating a boundary of the CM.

In FIG. 5, the silent segment detecting section 13 retrieves a beginning end time 243 of a silent segment which is most recently stored in the silent segment information 24. Then, the silent segment detecting section 13 determines whether or not a silent segment exists at a time point 15 seconds prior to the beginning end time by searching for the silent segment information 24 (step S21). As a result, when it is determined that the silent segment is searched (YES in step S21), the silent segment detecting section 13 adds 1 to the point 242 of each of the most recently stored silent segment and the silent segment searched in step S21 (step S22). On the other hand, as a result of step S21, when it is determined that the silent segment which might have appeared 15 seconds prior to the beginning end time of the most recently stored silent segment cannot be searched (NO in step S21), the silent segment detecting section 13 skips a process in step S22 and advances the point assessment process to step S23. Next, similar to step S21, the silent segment detecting section 13 determines whether or not a silent segment exists at a time point 30 seconds prior to the beginning end time of the most recently stored silent segment (step S23). As a result, when it is determined that the silent segment is searched (YES in step S23), the silent segment detecting section 13 adds 1 to the point 242 of each of the most recently stored silent segment and the currently searched silent segment (step S24). On the other hand, as a result of step S23, when it is determined that the silent segment which might have appeared 30 seconds prior to the beginning end time of the most recently stored silent segment cannot be searched (NO in step S23), the silent segment detecting section 13 skips a process in step S24 and advances the point assessment process to step S25. In step S25, similar to steps S21 and S23, the silent segment detecting section 13 determines whether or not a silent segment exists at a time point 60 seconds prior to the beginning end time of the most recently stored silent segment. When it is determined that the silent segment exists, the silent segment detecting section 13 adds 1 to the point 242 of each of the most recently stored silent segment and the currently searched silent segment, similar to steps S22 and S24. As such, the point assessment process in step S16 is finished. Note that in the above description, the silent segment information 24 is searched with respect to the beginning end time 243 of the silent segment. However, the present invention is not limited thereto. The silent segment information 24 may be searched with respect to the terminating end of the silent segment or any time point included in the silent segment.

Referring back to FIG. 3, after the process in step S4, the candidate segment detecting section 14 executes a candidate segment detecting process (step S5). The candidate segment detecting process is a process of detecting a segment having an audio power level greater than or equal to a predetermined threshold value as the candidate segment of the digest scene.

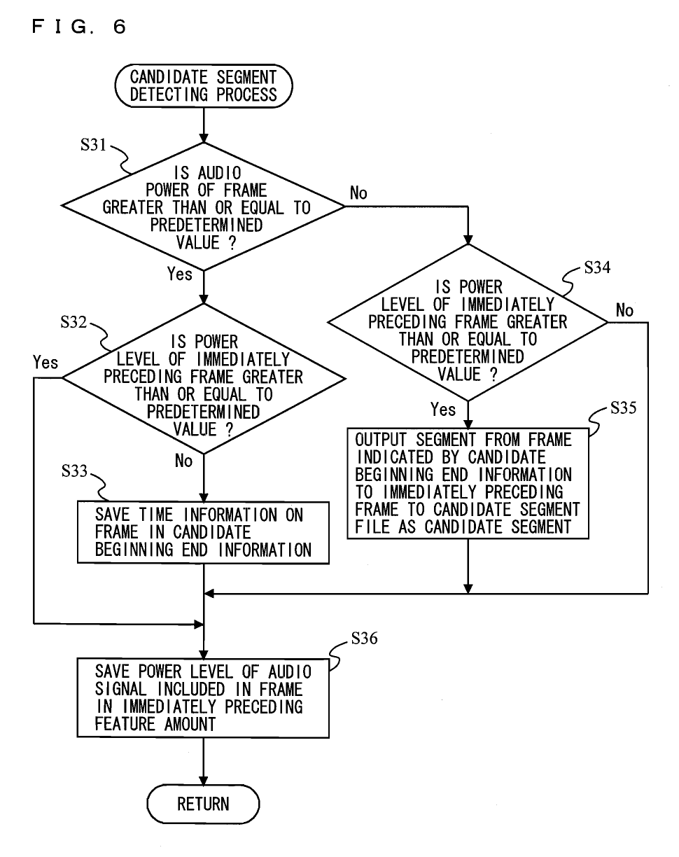

FIG. 6 is a flowchart illustrating details of the candidate segment detecting process shown in step S5. In FIG. 6, the candidate segment detecting section 14 determines whether or not the power level of the audio signal extracted in step S3 is greater than or equal to a predetermined threshold value (step S31). As a result, when it is determined that the power level is greater than or equal to the predetermined threshold value (YES in step S31), the candidate segment detecting section 14 subsequently determines whether or not the immediately preceding feature amount 212 is greater than or equal to the predetermined threshold value (step S32). As a result, when it is determined that the immediately preceding feature amount 212 is not greater than or equal to the predetermined threshold value (NO in step S32), the candidate segment detecting section 14 stores time information on the frame acquired in step S2 (the frame currently being processed) in the candidate beginning end information 23 (step S33). Note that immediately after the process is started, any information is not yet stored in the immediately preceding feature amount 212. Therefore, in this case, the process proceeds assuming that the value is not greater than or equal to the predetermined threshold value. On the other hand, when it is determined that the immediately preceding feature amount 212 is greater than or equal to the predetermined threshold value (YES in step S32), a candidate segment is continuing. Thus, the candidate segment detecting section 14 advances the process to step S36.

On the other hand, as a result of step S31, when it is determined that the power level, of the audio signal, calculated in step S3 is not greater than or equal to the predetermined threshold value (NO in step S31), the candidate segment detecting section 14 reads the immediately preceding feature amount 212, thereby determining whether or not a power level stored therein is greater than or equal to the predetermined threshold value (step S34). As a result, when it is determined that the power level is greater than or equal to the predetermined threshold value (NO in step S34), a continued candidate segment ends after the frame immediately preceding the current frame. Therefore, the candidate segment detecting section 14 outputs, to the candidate segment information 25, a segment from the candidate beginning end time stored in candidate beginning end information 23 to the time information 211 indicating a time of the frame immediately preceding the current frame as one candidate segment (step S35).

On the other hand, as a result of step S34, when it is determined that the value of the immediately preceding feature amount 212 is not greater than or equal to the predetermined threshold value (NO in step S34), a segment other than the candidate segment is continuing. Thus, the candidate segment detecting section 14 advances the process to step S36. Note that immediately after the process is started, any information is not yet stored in the immediately preceding feature amount 212. Therefore, in this case, the process proceeds assuming that the value is not greater than or equal to the predetermined threshold value. In step S36, the candidate segment detecting section 14 stores the power level of the audio signal acquired in step S3 in the immediately preceding feature amount 212 (step S36). As such, the candidate segment detecting process is finished.

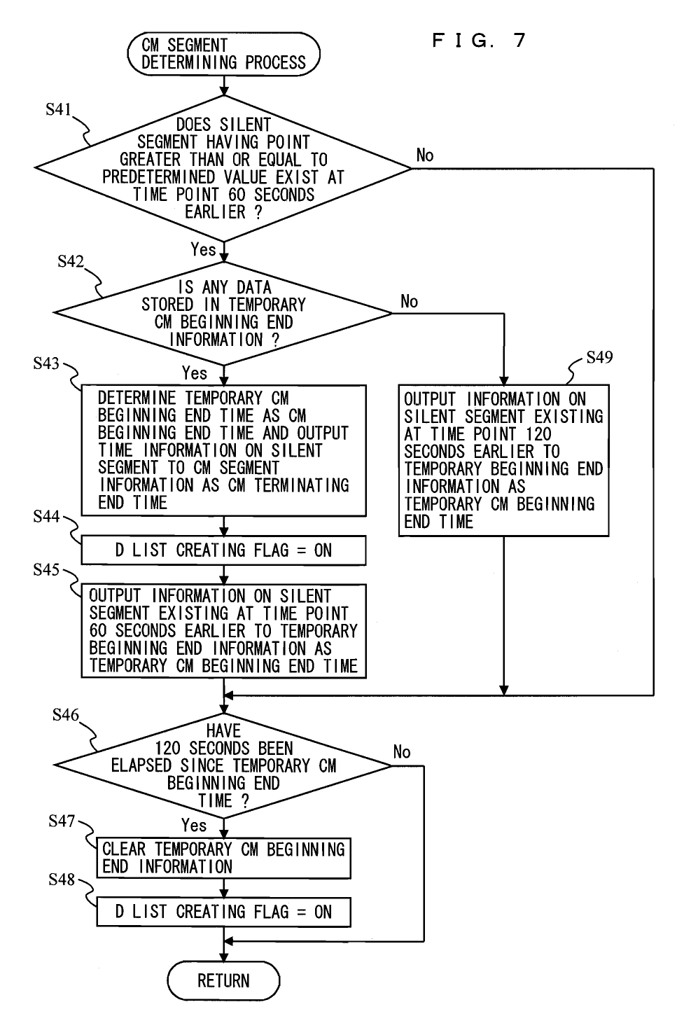

Referring back to FIG. 3, after the process in step S5, the CM segment determining section 15 executes a CM segment determining process (step S6) FIG. 7 is a flow chart illustrating details of the CM segment determining process shown in step S6. In FIG. 7, the CM segment determining section 15 searches the silent segment information 24, thereby determining whether or not a silent segment having the point 242 greater than or equal to a predetermined value (3 points, for example) exists at a time point 60 seconds prior to the current frame (step S41). In other words, it is determined whether or not a time point 60 seconds prior to the current frame is included in a silent segment. Note that a silent segment existing at a time point 60 seconds prior to the current frame is searched since the present embodiment assumes that a maximum length of one CM segment is 60 seconds. Thus, when it is assumed that the maximum length of one CM segment is 30 seconds, a silent segment existing at a time point 30 seconds prior to the current frame may be searched. As a result of step S41, when it is determined that the silent segment does not exist at the time point 60 seconds prior to the current frame (NO in step S41), the CM segment determining section 15 advances the process to step S46 to be described later.

On the other hand, as a result of step S41, when it is determined that the silent segment exists at the time point 60 seconds prior to the current frame (YES in step S41), the CM segment determining section 15 determines whether or not any data exists in the temporary CM beginning end information 26 (step S42). As a result, when it is determined that no data exists in the temporary CM beginning end information 26 (NO in step S42), the CM segment determining section 15 outputs time information on the searched silent segment to the temporary CM beginning end information 26 (step S49). On the other hand, when it is determined that any data already exists (YES in step S42), the CM segment determining section 15 retrieves a temporary beginning end time from the temporary CM beginning end information 26, and outputs, to the CM segment information 27, the retrieved temporary beginning end time associated with the CM number 271 as the CM beginning end time 272. In accordance with this, a terminating end time of the silent segment searched in step S41 (i.e., the silent segment existing at the time point 60 seconds prior to the current frame) is outputted to the CM segment information 27 as the CM terminating end time 273 (step S43).

Next, the CM segment determining section 15 sets a D list creating flag on (step S44). The D list creating flag is a flag for creating the digest scene list to be described later. Then, the CM segment determining section 15 outputs information on a terminating end time of the silent segment existing at the time point 60 seconds prior to the current frame as the beginning end time of the temporary CM beginning end information 26 (step S45).

Then, the CM segment determining section 15 determines whether or not 120 seconds or more have been elapsed since the beginning end time of the temporary CM beginning end information 26 (step S46). In other words, during 120 seconds after a silent segment which may be a beginning end of a CM is detected, if any other silent segment having the point 242 greater than or equal to the predetermined value does not exist, the silent segment is not determined as the beginning end of the CM. Note that a reference time period required for the determination is 120 seconds since the present embodiment assumes that the maximum length of one CM segment is 60 seconds. In other words, even if a beginning end candidate of a CM segment is once detected and then another silent segment is detected 60 seconds thereafter, another 60 seconds are still required to determine that the said another silent segment is a terminating end of the CM segment.

As a result of step S46, when it is determined that 120 seconds or more have been elapsed (YES in step S46), the CM segment determining section 15 clears the temporary CM beginning end information 26 (step S47). Then, the CM segment determining section 15 sets the D list creating flag on (step S48). On the other hand, when it is determined that 120 seconds or more have not been elapsed (NO in step S46), the process is to be finished. As such, the CM segment determining process is finished.

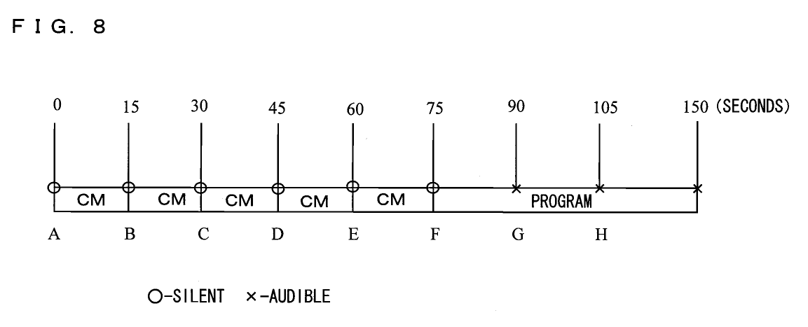

A supplemental description of the CM segment determining process will be provided with reference to FIG. 8. In FIG. 8, points A to G are silent segments and ends of CM segments arranged at intervals of 15 seconds. According to the aforementioned process, at the point E (60 seconds) shown in FIG. 8, the point A is determined as a temporary CM beginning end. Thereafter, at the point F (75 seconds), a segment from the point A to the point B is determined as a CM segment, and time information on the CM segment is outputted to the CM segment information 27. In accordance with this, the point B is determined as a new temporary CM beginning end. Thereafter, at the point G, a segment from the point B to the point C is determined as another CMs segment, and the segment is outputted to the CM segment information. In accordance with this, the point C is determined as another new temporary CM beginning end. As described above, according to the aforementioned process, a correct CM segment can be simultaneously determined while recording a program though a certain amount of delay time is generated.

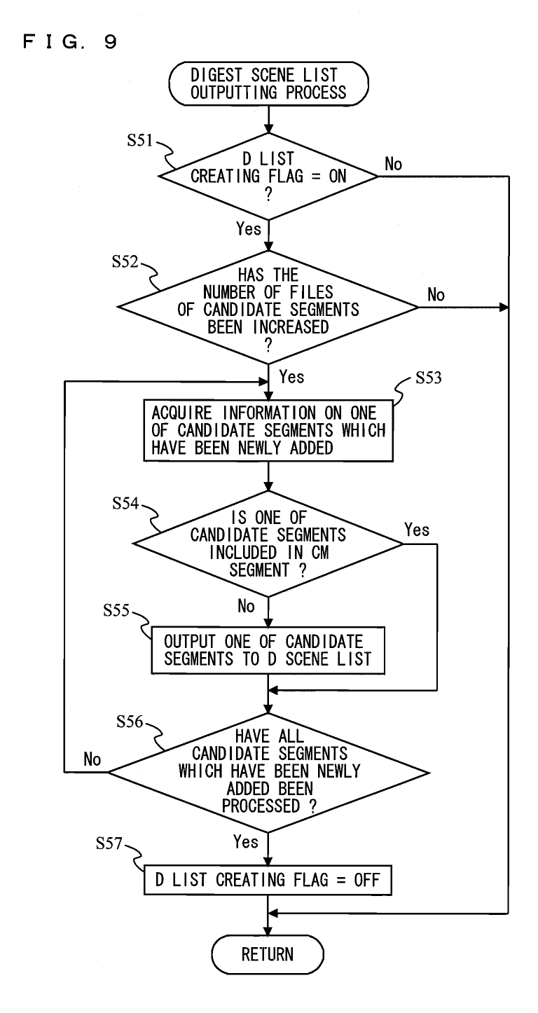

Referring back to FIG. 3, after the process in step S6, the digest list creating section 16 executes a digest scene list outputting process (step S7). FIG. 9 is a flowchart illustrating details of the digest scene list outputting process shown in step S7. In FIG. 9, the digest list creating section 16 determines whether or not the D list creating flag is on (step S51). As a result, when it is determined that the D list creating flag is not on (NO in step S51), the digest list creating section 16 finishes the process. On the other hand, when it is determined that the D list flag is on (YES is step S51), the digest list creating section 16 determines whether or not at least one candidate segment has been newly added to the candidate segment information 25 since the digest scene list outputting process was previously executed (step S52). As a result, when it is determined that the at least one candidate segment has not been newly added (NO is step S52), the digest list creating section 16 finishes the digest scene list creating process. On the other hand, when it is determined that the at least one candidate segment has been newly added since the digest scene list outputting process was preciously executed (YES in step S52), the digest list creating section 16 retrieves information on one of the at least one candidate segment which has been newly added (step S53). Then, the digest list creating section 16 determines whether or not the one of the at least one candidate segment is included in a CM segment by reading the CM segment information 27 (step S54). As a result, when it is determined that the one of the at least one candidate segment is not included in the CM segment (NO in step S54), the digest list creating section 16 outputs the information on one of the at least one candidate segment to the digest scene list 28 (step S55). On the other hand, when it is determined that the one of the at least one candidate segment is included in the CM segment (YES in step S54), the digest list creating section 16 advances the process to step S56. In other words, when a candidate segment is a CM segment, sorting is performed such that the candidate segment is not selected as a digest scene.

Next, the digest list creating section 16 determines whether or not a process of the sorting has been already performed on each of the at least one candidate segment which has been newly added (step S56). As a result, when it is determined that any of the at least one candidate segment which has been newly added still remains unprocessed (NO in step S56), the digest list creating section 16 returns to step S53 and repeats the process. On the other hand, when it is determined that the process of the sorting has been already performed on each of the at least one candidate segment which has been newly added, the digest list creating section 16 sets the D list creating flag off (step S57), and finishes the digest scene list outputting process. As such, the digest scene list creating process according to the first embodiment is finished.

As described above, in the first embodiment, digest candidate segments each simply having an audio power level greater than or equal to a predetermined value are simultaneously extracted while recording a program, and a segment corresponding to the CM segment is deducted from the digest candidate segments, thereby making it possible to simultaneously create a digest scene list obtained by extracting only digest scenes included in a program segment while recording the program. Therefore, it is unnecessary to separately execute a process of creating the digest scene list after finishing recording the program. Thus, it becomes possible to provide the user with a comfortable viewing environment with no process waiting time required for executing the process of creating the digest scene list.

In the above embodiment, the silent segment detecting section 13 executes the silent segment detecting process. However, the present invention is not limited thereto. The CM segment determining section 15 may detect a silent segment prior to the CM segment determining process.

Furthermore, as a scheme of detecting the digest scene, the audio power level is not always necessarily used. For example, sports is selected as a specific program genre, and a scene showing a slow motion (a repeated slow motion scene) may be specified based on a motion vector of an image and several scenes immediately preceding the scene showing the slow motion may be detected as scenes of excitement. Or a combination of text information assigned to a program and a feature amount included in an audio/video signal may be used to detect an important scene. As a matter of course, the present invention is not limited to the above-mentioned digest scene detecting schemes. Only if a digest scene is detected, any scheme may be used. Similarly, as a scheme of detecting the CM segment, the audio power level is not always necessarily used. For example, scene change points included in an image may be detected based on brightness level information of the image, thereby determining a CM segment based on an interval between time points at which the scene change points appear. In this case, the brightness level information of the image may be used as the feature amount.

Still furthermore, while recording a program, a follow-up reproduction of the program may be performed by using the digest list. In this case, the user issues an instruction to perform the follow-up reproduction. In response to the instruction, the reproduction controlling section 18 determines whether or not two minutes or more have been elapsed since recording is started. When it is determined that two minutes or more have been elapsed, by means of a digest list currently being generated by executing the aforementioned processes, only the digest scene is reproduced. On the other hand, when it is determined that only less than two minutes have been elapsed, the reproduction controlling section 18 performs a speed-up reproduction (reproduction at a speed 1.5 times as fast as a normal speed, for example). Thereafter, when the speed-up reproduction catches up with actual broadcast, the speed-up reproduction may be stopped and switched to an output of the actual time broadcast. Also, after finishing reproducing the digest scene, the user may decide on a subsequent reproduction. For example, a normal reproduction of the digest scene may be performed, or the digest scene may be thinned out to be reproduced. For example, in the case of a program of 60 minutes, it is assumed that when 30 minutes have been elapsed since the program starts, the user issues an instruction to perform the follow-up reproduction indicating “10-minute reproduction of a digest scene is requested”. In this case, based on a digest scene list which is currently being created, the reproduction controlling section 18 reproduces the digest scene so as to be finished in 10 minutes. Thereafter, the user will decide on what to view after finishing the reproduction of the digest scene, and the reproduction controlling section 18 will stand by to receive an instruction from the user. In other words, after the reproduction of the digest scene finishes, 40 minutes have been elapsed since the program starts. Therefore, in response to the instruction from the user, a 10-minute portion of the program broadcast during the reproduction of the digest scene may be thinned out to be reproduced or the speed-up reproduction may be performed on the 10-minute portion. Of course, the user may view the actual broadcast without reproducing the 10-minute portion of the program. In this case, the reproduction controlling section 18 finishes a reproduction process in response to the instruction from the user. As described above, according to the present embodiment, the digest scene list is being simultaneously created while recording the program. Thus, it becomes possible to perform digest reproduction even at any timing during recording of the program. Still furthermore, in the above embodiment, the CM segment is deducted from the digest candidate segments so as to create the digest scene information. However, a segment which should be deducted from the digest candidate segments is not limited to the CM segment. A segment displaying a static image, for example, may be detected so as to be deducted. For example, when a program is rebroadcast, there may be a case where a scene which cannot be broadcast within the program is generated due to licensing or portrait rights. In such a case, the program is broadcast after an editing is performed prior to being broadcast such that a static image (to which an indication “a display is not permitted” is attached) is displayed instead of the scene which cannot be broadcast. Therefore, a feature amount (0 of a motion vector of the image, for example) included in the static image is detected, thereby detecting a static image segment in which the static image continues to be displayed. Thereafter, the static image segment (i.e., broadcast-prohibited segment) may be deducted from the digest candidate segments so as to create the digest scene information. Such CM segment and segment having a predetermined characteristic such as the static image or the like are detected as a specific segment, and the detected specific segment is deducted from the digest candidate segments, thereby making it possible to create the digest list obtained by extracting only the digest scenes in an appropriate manner.

### Second Embodiment

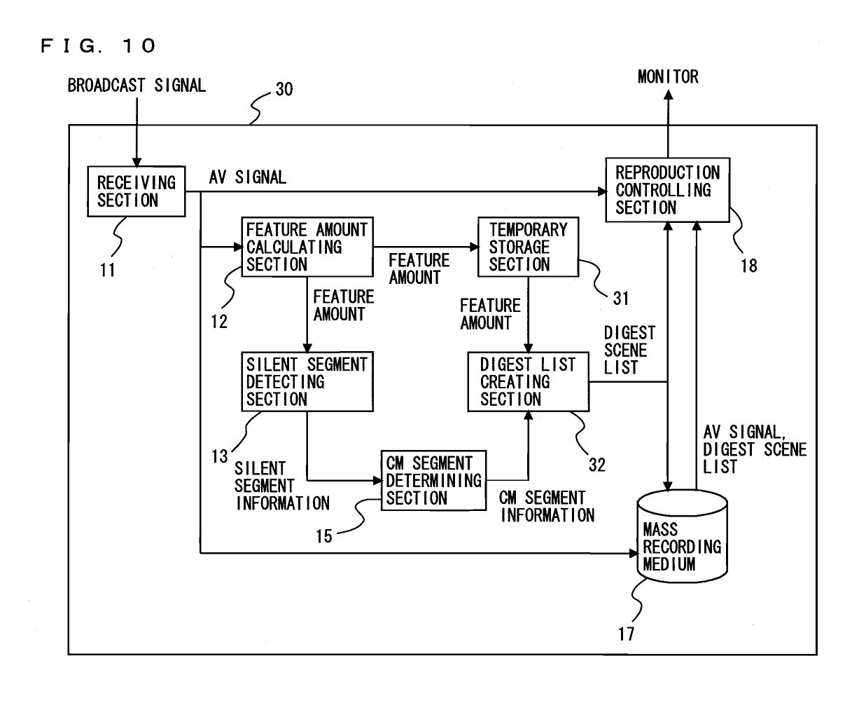

Next, a second embodiment of the present invention will be described with reference to FIGS. 10 to 13. In the first embodiment above, the candidate segment of a digest scene is always detected. In contrast, in the second embodiment, without detecting the candidate segment, the feature amount required for detecting the digest scene is stored for a predetermined time period, thereby detecting the digest scene based on the feature amount included in a segment other than a CM segment at a predetermined timing. FIG. 10 is a block diagram illustrating a configuration of a digest generation device 30 according to the second embodiment of the present invention. In FIG. 10, the feature amount calculating section 12 associates the calculated feature amount with time information so as to be stored in a temporary storage section 31 as a temporary accumulated feature amount 36. The temporary storage section 31 has a capacity enough to maintain a feature amount included in frames corresponding to a predetermined time period and the time information associated thereto. In the present embodiment, the temporary storage section 31 can maintain information on frames corresponding to two minutes. Also, the temporary storage section 31 is sequentially overwritten from old data due to a ring buffer scheme. Based on the CM segment information 27 and the feature amount stored in the temporary storage section 31, a digest list creating section 32 detects a digest scene from the segment other than the CM segment, thereby creating the digest scene list 28. Except for the aforementioned configuration, the digest generation device 30 according to the second embodiment has fundamentally the same configuration as that of the first embodiment. Therefore, portions having the same components as those of the first embodiment are denoted by the same reference numerals, and any descriptions thereof will be omitted.

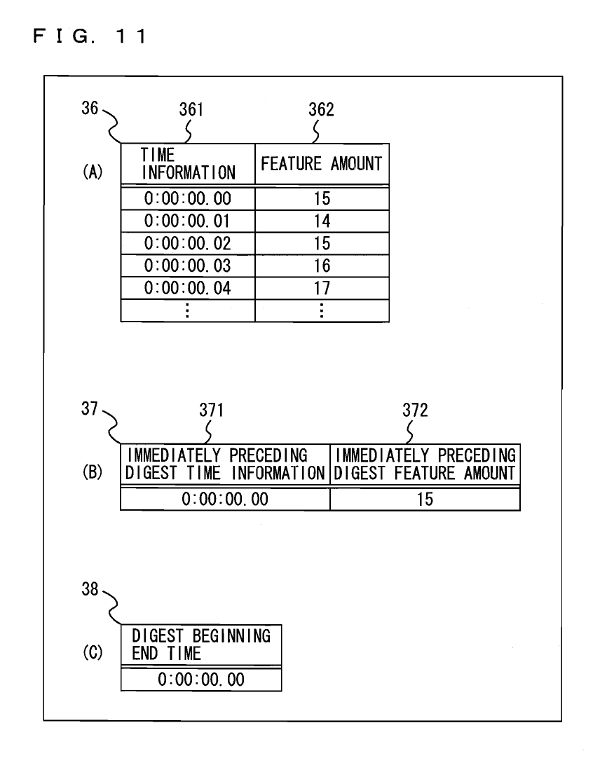

Next, data used in the second embodiment will be described with reference to FIG. 11. In the second embodiment, the temporary accumulated feature amount 36, immediately preceding digest information 37 and digest beginning end information 38 are used other than the data used in the first embodiment. The temporary accumulated feature amount 36 is used for detecting the digest scene, and has time information 361 and a feature amount 362. In the time information 361, time information on the frames is stored. In the feature amount 362, the feature amount, (the audio power level in the present embodiment) used for detecting the digest scene, which is calculated by the feature amount calculating section 12 is stored. The immediately preceding digest information 37 (FIG. 11(B)) is also used for detecting the digest scene, and has immediately preceding digest time information 371 and an immediately preceding digest feature amount 372. In the immediately preceding digest time information 371, time information on a frame immediately preceding a frame currently being processed is stored. In the immediately preceding digest feature amount 372, a feature amount included in the frame immediately preceding the frame currently being processed is stored. The digest beginning end information 38 (FIG. 11 (C)) has a digest beginning end time, and is used for detecting the digest scene.

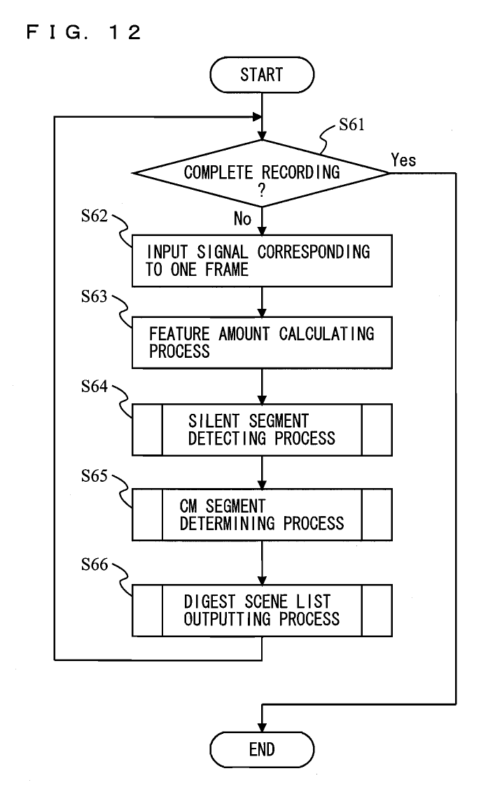

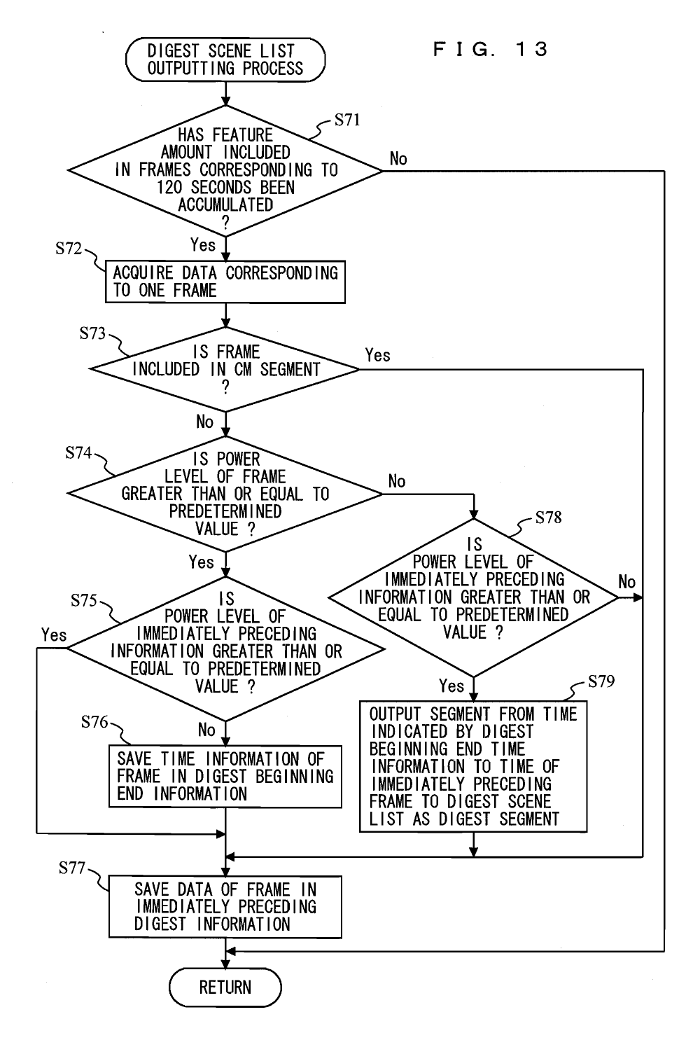

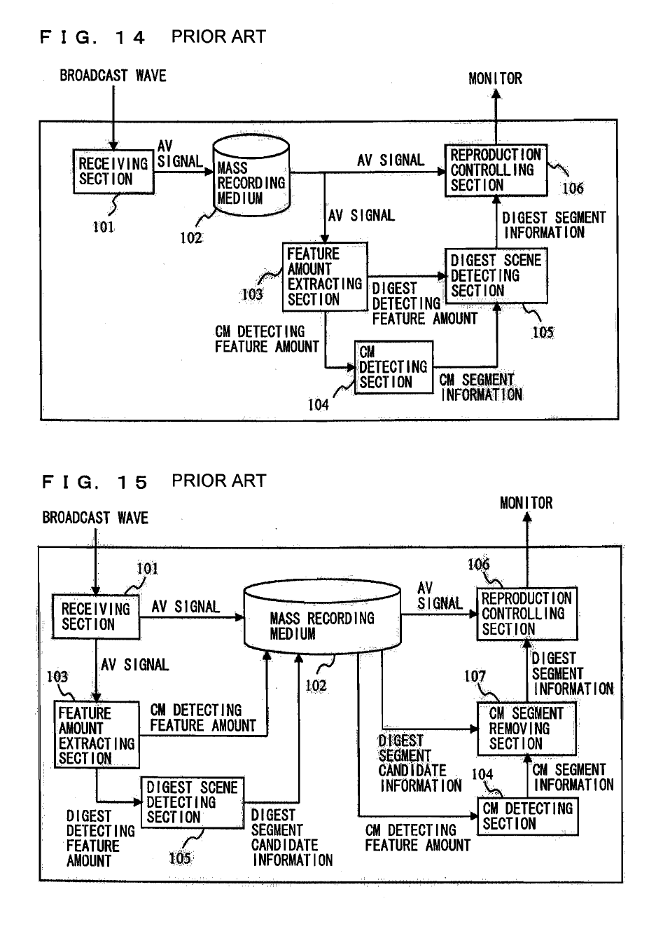

Hereinafter, the digest scene list creating process according to the second embodiment of the present invention will be described with reference to FIGS. 12 to 13. FIG. 12 is a flowchart illustrating a detailed operation of the digest scene list creating process according to the second embodiment. In FIG. 11, processes in steps S61 and S62 are the same as those in steps S1 and S2 described in the first embodiment with reference to FIG. 3, and thus any detailed descriptions thereof will be omitted. Similarly, the feature amount calculating process in step S63 is the same as that in step S3 described in the first embodiment with reference to FIG. 3, except that the calculated feature amount is outputted to the temporary storage section 31 in the second embodiment. Therefore, any detailed description thereof will be omitted. Also, the silent segment detecting process in step S64 is the same as that in step S4 described in the first embodiment with reference to FIG. 4, except that the feature amount (power level of an audio signal) calculated in step S63 is stored in the immediately preceding feature amount 212 at the end of the silent segment detecting process. Therefore, any detailed description thereof will be omitted.

Subsequent to step S64, the CM segment determining section 15 executes the CM segment determining process, thereby creating the CM segment information (step S65). An operation in step S65 is the same as that in step S6 described in the first embodiment with reference to FIG. 7. Therefore, any detailed description thereof will be omitted.

After the process in step S65, the digest list creating section 32 executes the digest list outputting process (step S66). FIG. 13 is a flowchart illustrating details of the digest list outputting process shown in step S66. In FIG. 13, the digest list creating section 32 determines whether or not a feature amount included in frames corresponding to 120 seconds has been accumulated in the temporary accumulated feature amount 36 (step S71). This is because the present embodiment assumes that the maximum length of the CM segment is 60 seconds. For example, in the case where a CM segment of 60 seconds exists at the beginning of a program, the maximum of 120 seconds is required for determining the CM segment. Thus, the digest list outputting process is not performed until at least 120 seconds have elapsed since the program starts. As a result of step S71, when it is determined that the feature amount included in the frames corresponding to 120 seconds has not yet been accumulated (No in step S71), the digest list outputting process is to be finished. On the other hand, when it is determined that the feature amount included in the frames corresponding to 120 seconds has been already accumulated (YES in step S71), the digest list creating section 16 retrieves the oldest time information 361 and feature amount 362 from the temporary accumulated feature amount 36 (step S72).

Thereafter, the digest list creating section 32 determines whether or not a time indicated by the time information 361 retrieved in step S72 exists in a CM segment by reading the CM segment information (step S73). As a result, when it is determined that the time exists in the CM segment (YES in step S73), the digest list creating section 32 finishes the digest list creating process. On the other hand, when it is determined that the time does not exist in the CM segment (NO in step S73), the digest list creating section 32 determines whether or not a value of the feature amount 362 is greater than or equal to a predetermined value (step S74). As a result, when it is determined that the value is greater than or equal to the predetermined value (YES in step S74), the digest list creating section 32 determines whether or not the immediately preceding digest feature amount 372 is greater than or equal to the predetermined value (step S75). That is, a change in the audio power level between a frame retrieved in step S72 and a frame immediately preceding the frame is determined. As a result, when it is determined that the immediately preceding digest feature amount 372 is not greater than or equal to the predetermined value (NO in step S75), the time information on the frame is saved in the digest beginning end information 38 (step S76). Note that when the digest list outputting process is initially executed, any information is not yet stored in the immediately preceding feature amount 212. Therefore, in this case, the process proceeds assuming that the value is not greater than or equal to the predetermined value. On the other hand, as a result of step S75, when it is determined that the immediately preceding digest feature amount 372 is greater than or equal to the predetermined value (YES in step S75), the digest list creating section 16 skips a process in step S76 and advances the process to step S77.

On the other hand, as a result of step S74, when it is determined that the value of the feature amount 362 is not greater than or equal to the predetermined value (NO in step S74), the digest list creating section 32 further determines whether or not the immediately preceding digest feature amount 372 is greater than or equal to the predetermined value (step S78). As a result, when it is determined that the immediately preceding digest feature amount 372 is not greater than or equal to the predetermined value (NO is step S78), the digest list creating section 16 finishes the digest list creating process. On the other hand, when it is determined that the immediately preceding digest feature amount 372 is greater than or equal to the predetermined value (YES in step S78), a continued silent segment ends after the frame immediately preceding the frame. Thus, the digest list creating section 32 outputs, to the digest scene list 28, a segment from the digest beginning end time indicated by the digest beginning end information 38 to a time indicated by the immediately preceding digest time information 371 as one digest segment (step S79). Next, the digest list creating section 16 saves the audio power level of the frame in the immediately preceding digest feature amount 372 (step S77). As such, the digest scene list creating process according to the second embodiment is finished.

As described above, in the second embodiment, a CM segment is simultaneously detected while recording a program, thereby making it possible to detect a digest scene from a program segment other than the CM segment. Therefore, it is unnecessary to separately execute a process of creating the digest scene list after finishing recording the program. Thus, it becomes possible to provide the user with a comfortable viewing environment with no process waiting time required for executing the process of creating the digest scene list.

Note that each of the above embodiments may be provided by a recording medium storing a program executed by a computer. In this case, the digest generation device (more precisely, a not shown control section thereof) may read a digest generation program stored on the recording medium, and execute the processes as shown in FIG. 3 and FIG. 12.

### INDUSTRIAL APPLICABILITY

A digest generation device, a digest generation method, a recording medium storing a digest generation program thereon, and an integrated circuit used in the digest generation device according to the present invention are capable of generating digest scene information while recording a program, and are applicable as an HDD recorder, a DVD recorder and the like.

1. A digest generation device for generating, when receiving broadcast signals of a program to be broadcast and recording the broadcast signals on a recording medium, digest scene information concerning the program, comprising:
a feature amount calculating section for calculating, each time the broadcast signals corresponding to a unit time period are received, at least one type of a feature amount indicating a characteristic of at least one of video and audio included in the broadcast signals based on the received broadcast signals corresponding to the unit time period;
a specific segment end detecting section for detecting time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end; and
a digest scene information creating section for determining, each time the feature amount is calculated, whether or not the broadcast signals included in segments, other than the specific segment, of an entire segment of the program are included in a digest scene based on the feature amount so as to generate digest scene information.

2. The digest generation device according to claim 1, wherein
the digest scene information creating section includes
a digest segment detecting section for detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount, and
determines, each time the specific segment end detecting section detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting section as the digest scene information.

3. The digest generation device according to claim 1, wherein
the digest scene information creating section includes
a temporary storage section for storing the calculated feature amount for a predetermined time period from a most recent calculation time point, and
determines, each time the feature amount is calculated, whether or not the most recent calculation time point of the feature amount stored in the temporary storage section is included in the specific segment from the beginning end to the terminating end which are detected by the specific segment end detecting section, and detects, when it is determined that the most recent calculation time point is not included in the specific segment, at least one content of the digest scene from contents included in the broadcast signals corresponding to the unit time period so as to generate the digest scene information.

4. The digest generating device according to claim 2, wherein
the feature amount calculating section calculates a first feature amount and a second feature amount,
the specific segment end detecting section determines the beginning end or the terminating end of the specific segment based on the first feature amount, and
the digest segment detecting section detects any of the digest candidate segments based on the second feature amount.

5. The digest generation device according to claim 1, wherein
the specific segment end detecting section includes:
a specific segment candidate detecting section for detecting, when the feature amount satisfies a predetermined condition, a segment including only the feature amount satisfying the condition as a specific segment candidate; and
a specific segment determining section for detecting a candidate of the beginning end or the terminating end of the specific segment based on a time difference between the specific segment candidate and another specific segment candidate, both of which are included in the program.

6. The digest generation device according to claim 5, wherein
each time the specific segment candidate is detected, the specific segment determining section determines, if a time point which is a predetermined time period prior to the detected specific segment candidate is included in an already-detected specific segment candidate, the time point which is the predetermined time period prior to the detected specific segment candidate as the beginning end of the specific segment and the detected specific segment candidate as the terminating end of the specific segment.

7. The digest generation device according to claim 5, wherein
the specific segment detecting section includes:
a determination section for determining, each time the specific segment candidate is detected, whether or not an already-detected specific segment candidate exists at a time point which is a predetermined first time period prior to a most recently detected specific segment candidate or at a time point which is a predetermined second time period prior to the most recently detected specific segment candidate;
an addition section for adding, when the determination section determines that the already-detected specific segment candidate exists at either of the time points, a point to each of the already-detected specific segment candidate and the most recently detected specific segment candidate;
a beginning end determining section for determining, each time a predetermined third time period is elapsed since a target candidate having the point greater than or equal to a predetermined value is detected, whether or not the specific segment candidate having the point greater than or equal to the predetermined value exists at a time point which is the predetermined third time period prior to the target candidate, and determining, if the specific segment candidate having the point greater than or equal to the predetermined value does not exist at the time point which is the predetermined third time period prior to the target candidate, the target candidate as the beginning end of the specific segment; and
a terminating end determining section for determining, each time the predetermined third time period is elapsed since the target candidate having the point greater than or equal to the predetermined value is detected, whether or not the specific segment candidate having the point greater than or equal to the predetermined value exists at a time point at which the predetermined third time period is elapsed, and determining, if the specific segment candidate having the point greater than or equal to the predetermined value does not exist at the time point at which the predetermined third time period is elapsed, the target candidate as the terminating end of the specific segment.

8. The digest generation device according to claim 5, wherein
the feature amount calculating section calculates an audio power level of an audio signal as the feature amount, and
the specific segment candidate detecting section detects a silent segment having a power level smaller than or equal to a predetermined value as the specific segment candidate.

9. The digest generation device according to claim 5, wherein
the feature amount calculating section calculates brightness level information obtained based on a video signal as the feature amount, and
the specific segment candidate detecting section detects a scene change point having a change amount, of the brightness level information, greater than or equal to a predetermined value as the specific segment candidate.

10. A digest generation method of generating, when receiving broadcast signals of a program to be broadcast and recording the broadcast signals on a recording medium, digest scene information concerning the program, comprising:
a feature amount calculating step of calculating, each time the broadcast signals corresponding to a unit time period are received, at least one type of a feature amount indicating a characteristic of at least one of video and audio included in the broadcast signals based on the received broadcast signals corresponding to the unit time period;
a specific segment end detecting step of detecting time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end; and
a digest scene information creating step of determining, each time the feature amount is calculated, whether or not the broadcast signals included in segments, other than the specific segment, of an entire segment of the program are included in a digest scene based on the feature amount so as to generate digest scene information.

11. The digest generation method according to claim 10, wherein
the digest scene information creating step includes
a digest segment detecting step of detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount, and
determines, each time the specific segment end detecting step detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting step as the digest scene information.

12. The digest generation method according to claim 10, wherein
the digest scene information creating step includes
a temporary storage step of storing the calculated feature amount for a predetermined time period from a most recent calculation time point, and
determines, each time the feature amount is calculated, whether or not the most recent calculation time point of the feature amount stored in the temporary storage step is included in the specific segment from the beginning end to the terminating end which are detected by the specific segment end detecting step, and detects, when it is determined that the most recent calculation time point is not included in the specific segment, at least one content of the digest scene from contents included in the broadcast signals corresponding to the unit time period so as to generate the digest scene information.

13. A recoding medium storing a digest generation program executed by a computer of a digest generation device for generating, when receiving broadcast signals of a program to be broadcast and recording the broadcast signals on a recording medium, digest scene information concerning the program, the digest generation program instructing the computer to execute:
a feature amount calculating step of calculating, each time the broadcast signals corresponding to a unit time period are received, at least one type of a feature amount indicating a characteristic of at least one of video and audio included in the broadcast signals based on the received broadcast signals corresponding to the unit time period;
a specific segment end detecting step of detecting time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end; and
a digest scene information creating step of determining, each time the feature amount is calculated, whether or not the broadcast signals included in segments, other than the specific segment, of an entire segment of the program are included in a digest scene based on the feature amount so as to generate digest scene information.

14. The recording medium according to claim 13, wherein
the digest scene information creating step includes
a digest segment detecting step of detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount, and
determines, each time the specific segment end detecting step detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting step as the digest scene information.

15. The recording medium according to claim 13, wherein
the digest scene information creating step includes
a temporary storage step of storing the calculated feature amount for a predetermined time period from a most recent calculation time point, and
determines, each time the feature amount is calculated, whether or not the most recent calculation time point of the feature amount stored in the temporary storage step is included in the specific segment from the beginning end to the terminating end which are detected by the specific segment end detecting step, and detects, when it is determined that the most recent calculation time point is not included in the specific segment, at least one content of the digest scene from contents included in the broadcast signals corresponding to the unit time period so as to generate the digest scene information.

16. An integrated circuit used for a digest generation device for generating, when receiving broadcast signals of a program to be broadcast and recording the broadcast signals on a recording medium, digest scene information concerning the program, comprising:
a feature amount calculating section for calculating, each time the broadcast signals corresponding to a unit time period are received, at least one type of a feature amount indicating a characteristic of at least one of video and audio included in the broadcast signals based on the received broadcast signals corresponding to the unit time period;
a specific segment end detecting section for detecting time points of a beginning end and a terminating end of a specific segment by determining, each time the feature amount is calculated, whether or not a predetermined time point included in a portion of signals, for which the feature amount is already calculated, among the received broadcast signals, is either the beginning end or the terminating end; and
a digest scene information creating section for determining, each time the feature amount is calculated, whether or not the broadcast signals included in segments, other than the specific segment, of an entire segment of the program are included in a digest scene based on the feature amount so as to generate digest scene information.

17. The integrated circuit according to claim 16, wherein
the digest scene information creating section includes
a digest segment detecting section for detecting digest candidate segments from the received broadcast signals by determining, each time the feature amount included in the broadcast signals corresponding to the unit time period is calculated, whether or not a content included in the broadcast signals corresponding to the unit time period is the digest scene based on the feature amount, and
determines, each time the specific segment end detecting section detects a pair of the beginning end and the terminating end of the specific segment, whether or not the specific segment from the beginning end to the terminating end overlaps one of the digest candidate segments, and generates information indicating at least one segment, other than the one of the digest candidate segments which overlaps the specific segment, included in the digest candidate segments detected by the digest segment detecting section as the digest scene information.

18. The integrated circuit according to claim 16, wherein
the digest scene information creating section includes
a temporary storage section for storing the calculated feature amount for a predetermined time period from a most recent calculation time point, and
determines, each time the feature amount is calculated, whether or not the most recent calculation time point of the feature amount stored in the temporary storage section is included in the specific segment from the beginning end to the terminating end which are detected by the specific segment end detecting section, and detects, when it is determined that the most recent calculation time point is not included in the specific segment, at least one content of the digest scene from contents included in the broadcast signals corresponding to the unit time period so as to generate the digest scene information.
